(19) United States
(12) Patent Application Publication
(10) Pub. No.: US 2025/0147314 A1
(43) Pub. Date: May 8, 2025

(54) OPTICAL WAVEGUIDE SYSTEM AND AUGMENTED REALITY DEVICE

(71) Applicant: GOERTEK OPTICAL TECHNOLOGY CO., LTD, Weifang, Shandong (CN)

(72) Inventors: En ZHAO, Weifang, Shandong (CN); Yi RAO, Weifang, Shandong (CN); Xiao WU, Weifang, Shandong (CN)

(21) Appl. No.: 18/837,618

(22) PCT Filed: Jun. 22, 2022
(86) PCT No.: PCT/CN2022/100322

§ 371 Date: Aug. 12, 2024

(30) Foreign Application Priority Data
Apr. 27, 2022 (CN) 202210453947.2

(51) Int. Cl. G02B 27/01

(52) U.S. Cl. CPC G02B 27/0172; G02B 2027/0118

(57) ABSTRACT

An optical waveguide system and an augmented reality device are disclosed and have advantages of reducing the light leakage rate and improving the light energy efficiency. The optical waveguide system comprises an optical waveguide, the optical waveguide comprises a first side face and a second side face opposite each other; the first side face is provided with a grating; the second side face is provided with a light-leakage prevention element configured to reduce light emitted from the second side face. The light-leakage prevention element may reflect, diffract or absorb light incident to the light-leakage prevention element. Therefore, light emitted from the second side face of the optical waveguide (1) can be reduced, that is, a light leakage phenomenon is reduced; and the light can also be reflected to the grating by reflection or diffraction, thereby improving the utilization rate of light energy, that is, improving the light efficiency.

### TECHNICAL FIELD

The present disclosure relates to a field of augmented reality devices, and in particular, to an optical waveguide system and an augmented reality device.

### BACKGROUND

Lens of current augmented reality (AR) devices having optical waveguide systems based on diffraction gratings all have problems of leaking virtual image light to an external environment, that is, virtual image information currently viewed by a wearer wearing the augmented reality device will be leaked to outsiders at the same time, causing the wearer's privacy to be leaked at the same time, which seriously affects the wearing experience and comfort of the augmented reality device. Meanwhile, in order to ensure the uniformity and the transmittance of the exit pupil, the current augmented reality devices usually use gratings with extremely low diffraction efficiency, which leads to very low light efficiency of the optical waveguide system, resulting in low brightness and high power consumption, which seriously limits the application scenarios and battery life of the augmented reality devices.

In view of this, it is necessary to provide a new optical waveguide system and augmented reality device to solve or at least alleviate the above technical defects.

### SUMMARY

A main object of the present disclosure is to provide an optical waveguide system and an augmented reality device, aiming to solve technical problems of high light leakage rate and low light efficiency of the optical waveguide system in the related art.

To achieve the above object, according to one aspect of the present disclosure, the present disclosure provides an optical waveguide system, including an optical waveguide, wherein the optical waveguide includes a first side face and a second side face opposite to each other, wherein the first side face is provided with a grating, and the second side face is provided with a light-leakage prevention element, wherein the light-leakage prevention element is configured to reduce light emitted from a direction towards the second side face.

In one embodiment, the light-leakage prevention element is configured to reflect light incident from the optical waveguide to the light-leakage prevention element, and an operating wavelength band of the light-leakage prevention element is consistent with an operating wavelength band of the grating.

In one embodiment, the light-leakage prevention element is configured to reflect light incident from the optical waveguide to the light-leakage prevention element, an operating wavelength band of the light-leakage prevention element is included in an operating wavelength band of the grating, and a difference between a first central wavelength of the operating wavelength band of the light-leakage prevention element and a second central wavelength of the operating wavelength band of the grating is less than a first preset value.

In one embodiment, a ratio between a width of the operating wavelength band of the light-leakage prevention element and a width of the operating wavelength band of the grating is smaller than a preset ratio, and the first central wavelength of the operating wavelength band of the light-leakage prevention element is the same as the second central wavelength of the operating wavelength band of the grating.

In one embodiment, the grating includes a left side close to incident light and a right side opposite to the left side, and a reflection angle bandwidth range of the light-leakage prevention element includes an angle range from an edge field of view of the left side of the grating to an edge field of view of the right side of the grating.

In one embodiment, within the reflection angle bandwidth range, a difference between reflectivity or diffraction efficiency corresponding to incident light at different angles is less than a second preset value; or within the reflection angle bandwidth range, a fluctuation of the difference between reflectivity or diffraction efficiency corresponding to the incident light at different angles is less than a third preset value.

In one embodiment, the second preset value is in a range of 5% to 10%, and the third preset value is in a range of 1% to 10%.

In one embodiment, the light-leakage prevention element is configured to absorb light incident from the optical waveguide to the light-leakage prevention element, and an absorption wavelength band of the light-leakage prevention element is consistent with an operating wavelength band of the grating.

In one embodiment, the light-leakage prevention element is configured to absorb light incident from the optical waveguide to the light-leakage prevention element, an absorption wavelength band of the light-leakage prevention element is included in an operating wavelength band of the grating, and a difference between a third central wavelength of the absorption wavelength band of the light-leakage prevention element and a fourth central wavelength of the operating wavelength band of the grating is less than a fourth preset value.

In one embodiment, a ratio between a width of the absorption wavelength band of the light-leakage prevention element and a width of the operating wavelength band of the grating is smaller than a preset ratio, and the third central wavelength of the absorption wavelength band of the light-leakage prevention element is the same as the fourth central wavelength of the operating wavelength band of the grating.

In one embodiment, the grating includes a left side close to incident light and a right side opposite to the left side, and an absorption angle bandwidth range of the light-leakage prevention element includes an angle range from an edge field of view of the left side of the grating to an edge field of view of the right side of the grating.

In one embodiment, within the absorption angle bandwidth range of the light-leakage prevention element, a difference between transmittance corresponding to incident light at different angles is less than a fifth preset value; or
within the absorption angle bandwidth range of the light-leakage prevention element, a fluctuation of the difference between transmittance corresponding to the incident light at different angles is less than a sixth preset value.

In one embodiment, the fifth preset value is in a range of 5% to 10%, and the sixth preset value is in a range of 1% to 10%.

In one embodiment, the light-leakage prevention element includes an absorption element and a reflection element which are stacked, light transmittance of the absorption element in an operating wavelength band is greater than light transmittance of the reflection element in an operating wavelength band, and the light transmittance of the absorption element in a non-operating wavelength band is less than the light transmittance of the reflection element in a non-operating wavelength band.

In one embodiment, the reflection element is disposed on a side of the light-leakage prevention element close to the optical waveguide.

According to another aspect of the present disclosure, the present disclosure further provides an augmented reality device comprising the optical waveguide system as described above.

In the above solution, the optical waveguide system includes an optical waveguide, and the optical waveguide includes a first side face and a second side face opposite to each other, the first side face is provided with a grating, and the second side face is provided with a light-leakage prevention element, and the light-leakage prevention element is configured to reduce the light emitted from the second side face. By arranging the light-leakage prevention element on a side of the optical waveguide that faces away from the grating, the light-leakage prevention element may reflect, diffract or absorb the light incident to the light-leakage prevention element. Therefore, the light emitted from the second side face of the optical waveguide can be reduced, that is, a light leakage phenomenon is reduced; and the light can also be reflected to the grating by reflection or diffraction, thereby improving the utilization rate of light energy, that is, improving the light efficiency. The disclosure has advantages of reducing the light leakage rate and improve the light energy efficiency.

### BRIEF DESCRIPTION OF DRAWINGS

In order to more clearly illustrate embodiments of the present disclosure or technical solutions in the related art, the drawings required to be used in the embodiments or the description of the related art will be briefly introduced below. Obviously, the drawings described below are only some embodiments of the present disclosure. For ordinary persons skilled in the art, other drawings can be obtained based on the structures shown in these drawings without paying any creative work.

FIG. 1 is a schematic diagram of a structure of an optical waveguide system in the related art;

FIG. 2 is a schematic diagram of an optical waveguide system and an optical path according to an embodiment of the present disclosure;

FIG. 3 is a graph illustrating the relationship between the diffraction efficiency and the wavelength of the light-leakage prevention element and the grating in FIG. 2;

FIG. 4 is a schematic diagram of an optical waveguide system and an optical path according to another embodiment of the present disclosure;

FIG. 5 is a graph illustrating the relationship between the reflectivity or the diffraction rate of the light-leakage prevention element and the angle in FIG. 4;

FIG. 6 is a schematic diagram of an optical waveguide system and an optical path according to yet another embodiment of the present disclosure;

FIG. 7 is a graph illustrating the relationship between the diffraction efficiency, the light transmittance and the wavelength of the light-leakage prevention element and the grating in FIG. 6;

FIG. 8 is a schematic diagram of an optical waveguide system and an optical path according to still another embodiment of the present disclosure;

FIG. 9 is a graph illustrating the relationship between the transmittance of the light-leakage prevention element and the field of view in FIG. 8;

FIG. 10 is a schematic diagram of an optical waveguide system and an optical path according to still yet another embodiment of the present disclosure;

FIG. 11 is a graph illustrating the relationship between the ambient light transmittance and wavelength of the light-leakage prevention element in FIG. 10;

FIG. 12 is a schematic diagram of an optical waveguide system and an optical path according to still further yet another embodiment of the present disclosure; and

FIG. 13 is a graph illustrating the relationship between the ambient light transmittance and wavelength of the combined light-leakage prevention element, the absorption element, and the reflection element, in FIG. 12.

### DESCRIPTION OF REFERENCE NUMBERS

1. optical waveguide; 11. first side face; 12. second side face; 2. grating; 21. left side; 22. right side; 3. light-leakage prevention element; 4. human eye; 5. combined light-leakage prevention element.

The achievement of purpose, characteristics and advantages of the present disclosure will be further explained in conjunction with the embodiments and with reference to the accompanying drawings.

### DETAILED DESCRIPTIONS

The following will be combined with the drawings in the embodiments of the present disclosure to clearly and completely describe the technical solutions in the embodiments of the present disclosure. Obviously, the described embodiments are only part of the embodiments of the present disclosure, not all of the embodiments. Based on the embodiments of the present disclosure, all other embodiments obtained by ordinary technicians in this field without creative work are within the scope of protection of the present disclosure.

It should be noted that all directional indications (such as up, down, etc.) in the embodiments of the present disclosure are only configured to explain the relative position relationship, movement status, etc. between the components in a certain specific posture (as shown in the accompanying drawings). If the specific posture changes, the directional indication will also change accordingly.

In addition, in the present disclosure, descriptions such as “first”, “second”, etc. are only used for descriptive purposes and cannot be understood as indicating or implying their relative importance or implicitly indicating the number of the indicated technical features. Therefore, the features defined as “first” and “second” may explicitly or implicitly include at least one of the features.

Furthermore, the technical solutions between the various embodiments of the present disclosure may be combined with each other, but this must be based on the fact that they can be implemented by ordinary persons in the art. When the combination of technical solutions is mutually contradictory or cannot be implemented, it should be deemed that such combination of technical solutions does not exist and is not within the scope of protection required by the present disclosure.

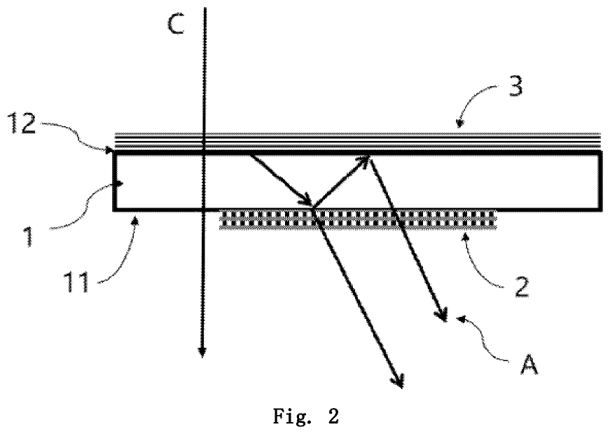

Referring to FIGS. 2 to 11, according to one aspect of the present disclosure, the present disclosure provides an optical waveguide system, comprising an optical waveguide 1, wherein the optical waveguide 1 includes a first side face 11 and a second side face 12 opposite to each other, wherein the first side face 11 is provided with a grating 2, and the second side face 12 is provided with a light-leakage prevention element 3, and the light-leakage prevention element 3 is configured to reduce light emitted from the second side face 12.

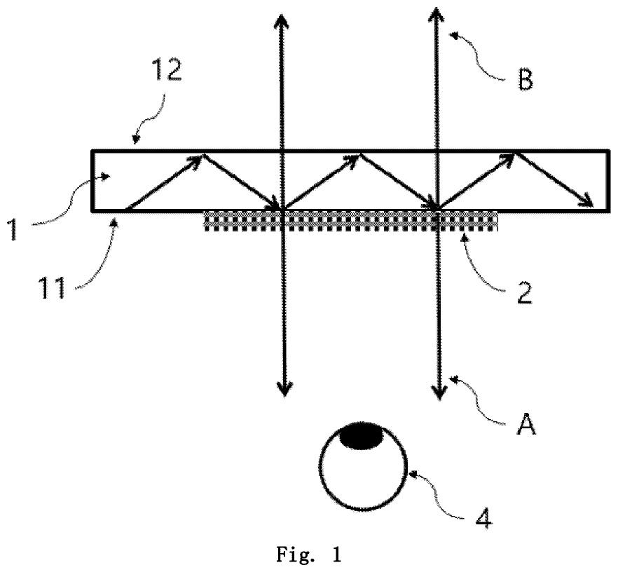

Referring to FIG. 1, light A in FIG. 1 represents imaging light, and light B represents leakage light. In the current optical waveguide system, the grating 2 is arranged on the optical waveguide 1, and the light incident on the optical waveguide 1 is reflected in the optical waveguide 1 and then emitted from one side of the grating 2, and the human eye 4 receives the imaging light on one side of the grating 2. However, at the same time, some light will be emitted from the side of the optical waveguide 1 that faces away from the grating 2 (i.e., the second side 12). This part of light can be called leakage light, so that the virtual image information currently viewed by the wearer will also be leaked to outsiders, causing privacy leakage, which seriously affects the wearing experience and comfort of AR glasses. Meanwhile, in order to ensure the uniformity and the transmittance of the exit pupil, only the grating 2 with extremely low diffraction efficiency can be used, which leads to very low light efficiency of the optical waveguide system, and there are defects of low brightness and high-power consumption. In the above embodiment, by arranging the light-leakage prevention element 3 on a side of the optical waveguide 1 that faces away from the grating 2, the light-leakage prevention element 3 may reflect, diffract or absorb the light incident to the light-leakage prevention element 3. Therefore, the light emitted from the second side face 12 of the optical waveguide 1 can be reduced, that is, the light leakage phenomenon can be reduced; and the light can also be reflected to the grating 2 by reflection or diffraction, thereby improving the utilization rate of light energy, that is, improving the light efficiency. This embodiment has advantages of reducing the light leakage rate and improving the light energy efficiency.

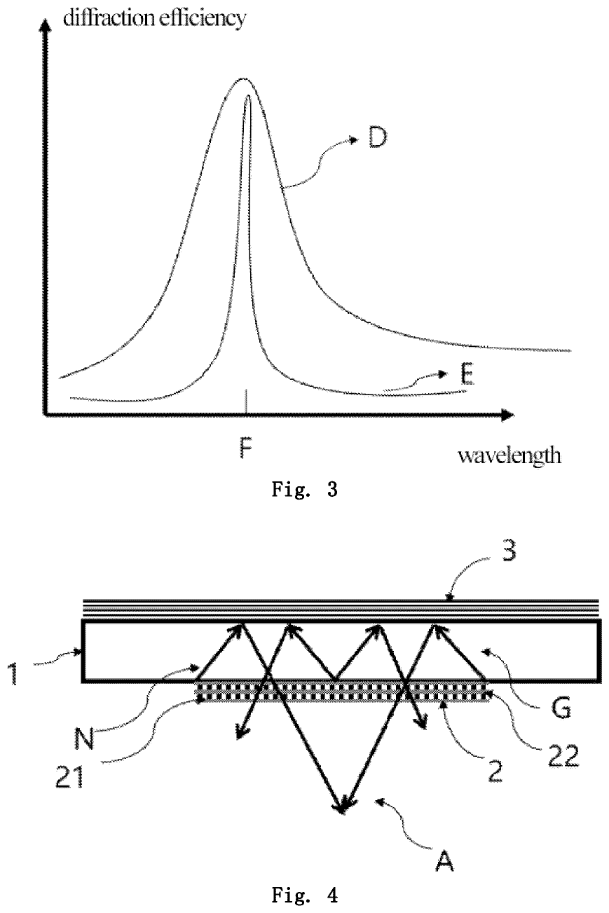

Referring to FIGS. 2 and 3, in FIG. 2, light A represents imaging light, light C represents ambient light, and in FIG. 3, the curve D represents an operating wavelength band of the grating 2, the curve E represents an operating wavelength band of the light-leakage prevention element 3, and F represents a central wavelength.

In a specific embodiment, the light-leakage prevention element 3 is configured to reflect the light incident from the optical waveguide 1 to the light-leakage prevention element 3, and the operating wavelength band of the light-leakage prevention element 3 is consistent with the operating wavelength band of the grating 2. In this way, the light-leakage prevention element 3 can maximally reflect the light incident on the light-leakage prevention element 3 into the optical waveguide 1, minimize the leakage of light, and the reflected light can be reflected from the grating 2 to the human eye 4 and become imaging light, which can effectively utilize light energy. This embodiment can not only minimize light leakage, reduce and avoid the risk of privacy leakage of the wearer, but also reuse the leaked light, to increase the light efficiency of the optical waveguide system.

Please continue to refer to FIGS. 2 and 3. In one embodiment, the light-leakage prevention element 3 is configured to reflect the light incident from the optical waveguide 1 to the light-leakage prevention element 3. The operating wavelength band of the light-leakage prevention element 3 is included in the operating wavelength band of the grating 2, and a difference between a first central wavelength of the operating wavelength band of the light-leakage prevention element 3 and a second central wavelength of the operating wavelength band of the grating 2 is less than the first preset value. That is, the first central wavelength of the operating wavelength band of the light-leakage prevention element 3 is very close to or consistent with the second central wavelength of the operating wavelength band of the grating 2, and the band intensity corresponding to the central wavelength is the largest. This embodiment can reflect the light within the strong band range to prevent light leakage; at the same time, the operating wavelength band of the light-leakage prevention element 3 is included in the operating wavelength band of the grating 2, that is, compared with the previous embodiment, the operating wavelength band of the light-leakage prevention element 3 is set narrower, the interference of the light-leakage prevention element 3 with the ambient light can also be reduced. The first preset value here can be in a range of 5%-10%, and those skilled in the art can set it according to actual needs.

Please continue to refer to FIG. 2 and FIG. 3. In one embodiment, a ratio between the width of the operating wavelength band of the light-leakage prevention element 3 and the width of the operating wavelength band of the grating 2 is smaller than a preset ratio, and the first central wavelength of the operating wavelength band of the light-leakage prevention element 3 is the same as the second central wavelength of the operating wavelength band of the grating 2. In this embodiment, the first central wavelength of the operating wavelength band of the light-leakage prevention element 3 is the same as the second central wavelength of the operating wavelength band of the grating 2, and the light within the range with the strongest reflection intensity can be reflected in a narrower band. The operating wavelength band of the light-leakage prevention element 3 is designed to be very narrow, and is within a very small range comparing to the operating wavelength band of the grating 2. Compared with the previous embodiment, the interference of the light-leakage prevention element 3 with the ambient light can be further reduced.

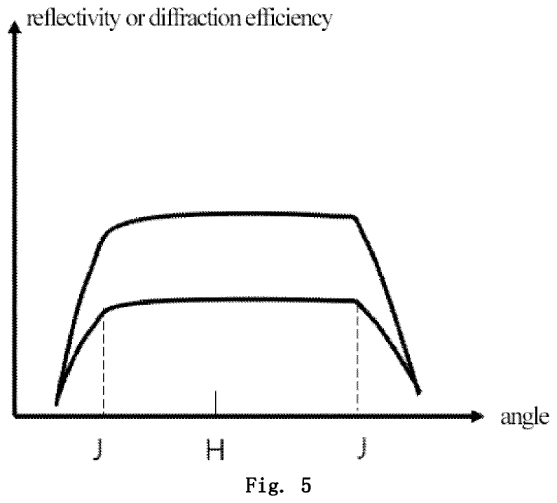

Referring to FIG. 4 and FIG. 5, in FIG. 4, light A represents imaging light, light N represents light from the edge field of view of the left side, light G represents light from the edge field of view of the right side, and in FIG. 5, point H represents a central field of view, point J represents an edge field of view, and two curves in FIG. 5 represent light-leakage prevention elements 3 with two types of different reflectivity or diffraction rates. In one embodiment, the grating 2 includes a left side 21 close to the incident light and a right side 22 opposite to the left side 21, and the reflection angle bandwidth range of the light-leakage prevention element 3 includes the angle range from the edge field of view of the left side of the grating 2 to the edge field of view of the right side of the grating 2. Within the reflection angle bandwidth range, the difference between reflectivity or diffraction rate corresponding to incident light at different angles is less than the second preset value; or within the reflection angle bandwidth range, the fluctuation of the difference between reflectivity or diffraction rate corresponding to incident light at different angles is less than the third preset value. Within the reflection angle bandwidth range, the reflectivity or diffraction efficiency of the light-leakage prevention element 3 is uniform or approximately uniform. Referring to FIG. 5, the angle-related spectrum shows that different incident angles within the reflection angle bandwidth have the same reflectivity or diffraction efficiency, or the reflectivity or the diffraction efficiency corresponding to different angles within the range is not much different from each other. The uniformity of the reflectivity or the diffraction efficiency can ensure that the light-leakage prevention element 3 can effectively prevent information image leakage in the entire field of view, and ensure the uniform distribution of the image light and the uniformity of the wearer observing the outside through the system.

In one embodiment, the second preset value is in a range of 5% to 10%, and the third preset value is in a range of 1% to 10%. Those skilled in the art can set the value range according to actual needs.

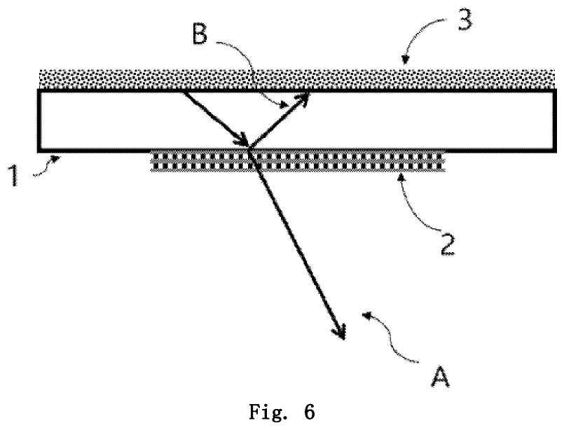

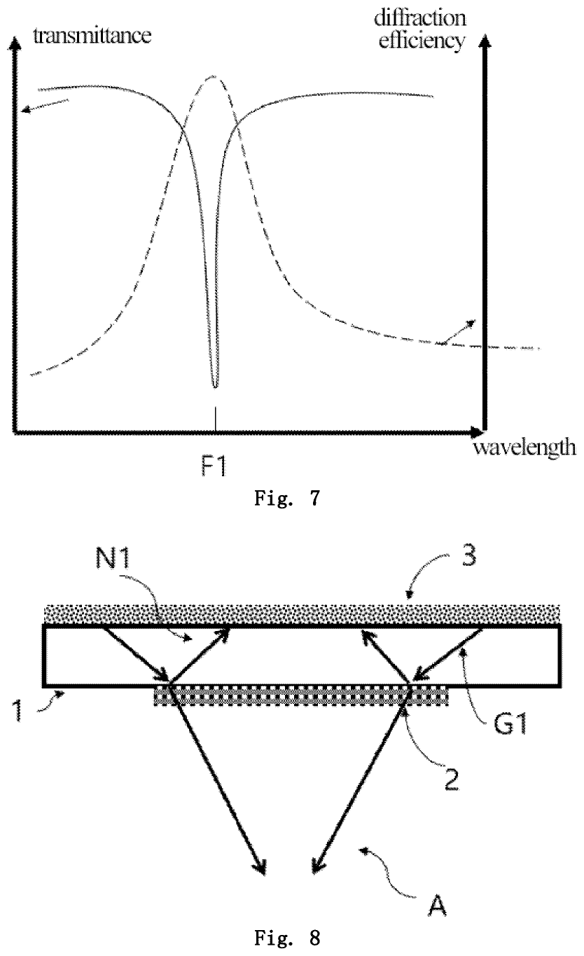

Referring to FIGS. 6 and 7, in FIG. 6, light A represents imaging light, light B represents leakage light, and in FIG. 7, F1 represents the central wavelength. In one embodiment, the light-leakage prevention element 3 is configured to absorb light incident from the optical waveguide 1 to the light-leakage prevention element 3, and the absorption wavelength band of the light-leakage prevention element 3 is consistent with the operating wavelength band of the grating 2. In this way, the light-leakage prevention element 3 can absorb the light incident on the light-leakage prevention element 3 to the maximum extent, and minimize the leakage of light.

Please continue to refer to FIGS. 6 and 7. In one embodiment, the light-leakage prevention element 3 is configured to absorb the light incident from the optical waveguide 1 to the light-leakage prevention element 3. The absorption wavelength band of the light-leakage prevention element 3 is included in the operating wavelength band of the grating 2, and the difference between the third central wavelength of the absorption wavelength band of the light-leakage prevention element 3 and the fourth central wavelength of the operating wavelength band of the grating 2 is less than the fourth preset value. That is, the third central wavelength of the operating wavelength band of the light-leakage prevention element 3 is very close to or has the same wavelength as the fourth central wavelength of the operating wavelength band of the grating 2, and the band intensity corresponding to the central wavelength is the largest. This embodiment can absorb light within the strong band range to prevent light leakage; at the same time, the operating wavelength band of the light-leakage prevention element 3 is included in the operating wavelength band of the grating 2, that is, compared with the previous embodiment, the absorption wavelength band of the light-leakage prevention element 3 is set narrower, which can also reduce the interference of the light-leakage prevention element 3 with the ambient light.

Please continue to refer to FIG. 6 and FIG. 7. In one embodiment, a ratio between the width of the operating wavelength band of the light-leakage prevention element 3 and the width of the operating wavelength band of the grating 2 is smaller than a preset ratio, and the third central wavelength of the absorption wavelength band of the light-leakage prevention element 3 is the same as the fourth central wavelength of the operating wavelength band of the grating 2. In this embodiment, the third central wavelength of the absorption wavelength band of the light-leakage prevention element 3 is the same as the fourth central wavelength of the operating wavelength band of the grating 2, and light within the range with the strongest intensity can be absorbed within a narrower band. The operating wavelength band of the light-leakage prevention element 3 is designed to be very narrow, and is within a very small range comparing with the operating wavelength band of the grating 2. Compared with the previous embodiment, the interference of the light-leakage prevention element 3 with the ambient light can be further reduced.

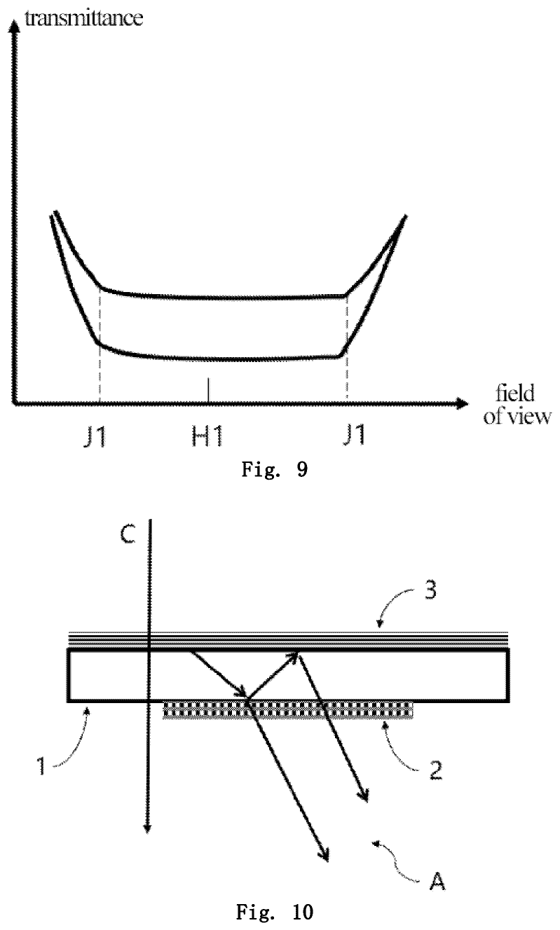

Referring to FIG. 8 and FIG. 9, in FIG. 8, light A represents imaging light, light N1 represents light at the edge field of view of the left side, light G1 represents light at the edge field of view of the right side, and in FIG. 9, point H1 represents the central field of view, point J1 represents the edge field of view, and two curves in FIG. 9 represent the light-leakage prevention elements 3 with two types of different transmittances. In one embodiment, the grating 2 includes a left side 21 close to the incident light and a right side 22 opposite to the left side 21, and the absorption angle bandwidth range of the light-leakage prevention element 3 includes an angle range from the edge field of view of the left side 21 of the grating 2 to the edge field of view of the right side 22 of the grating 2. Within the absorption angle bandwidth range of the light-leakage prevention element 3, the difference between transmittance corresponding to incident light at different angles is less than the fifth preset value; or within the absorption angle bandwidth range of the light-leakage prevention element 3, the fluctuation of the difference between transmittance corresponding to the incident light at different angles is less than the sixth preset value. Within the absorption angle bandwidth range, the transmittance of the light-leakage prevention element 3 is uniform or approximately uniform. Referring to FIG. 9, the angle-related spectrum shows that different incident angles within the absorption angle bandwidth range have the same transmittance, or the transmittances corresponding to different angles within the range are not much different from each other. The uniformity of transmittance can ensure that the light-leakage prevention element 3 can effectively prevent information image leakage in the entire field of view, and ensure the uniform distribution of image light and the uniformity of the wearer observing the outside through the system.

In one embodiment, the fifth preset value is in a range of 5% to 10%, and the sixth preset value is in a range of 1% to 10%. Those skilled in the art can set the value range according to actual needs.

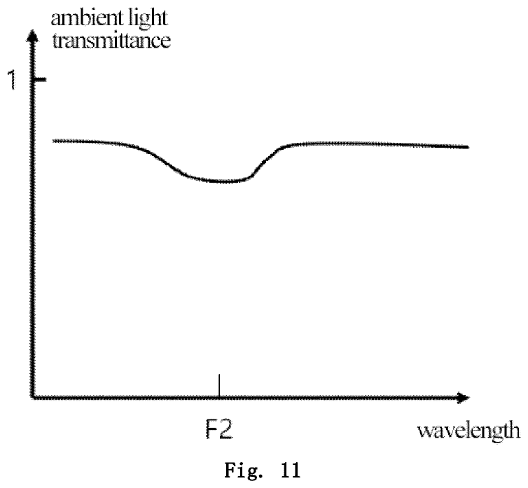

Referring to FIGS. 10 and 11, in FIG. 10, light A represents imaging light, and light C represents ambient light, and in FIG. 11, F2 represents the central wavelength. When the light-leakage prevention element 3 is in a reflective state or a diffraction state, in addition to responding to the light leakage of the grating 2, a portion of the ambient light will be reflected or diffracted when passing through the light-leakage prevention element 3. Therefore, when the wearer observes the outside through it, he will see the phenomenon of uneven brightness and color cast, especially when the reflectivity or the diffraction efficiency of the light-leakage prevention element 3 needs to be higher to improve the anti-leakage effect, such a phenomenon will be more obvious.

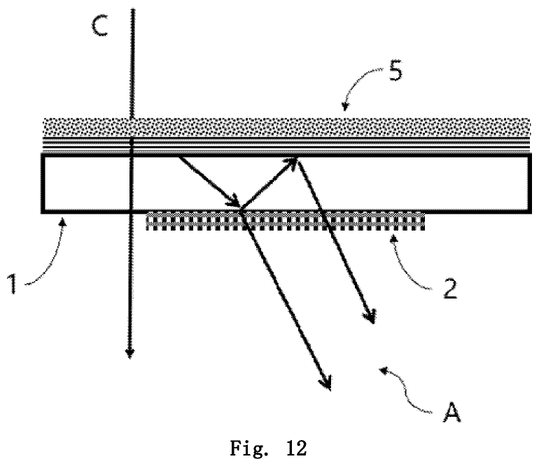

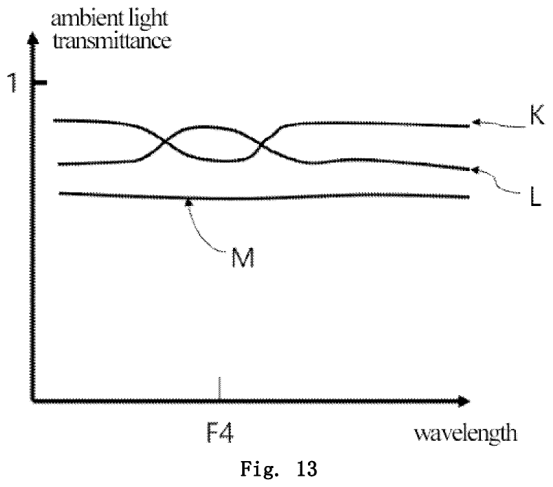

Referring to FIGS. 12 and 13, FIG. 12 is a schematic diagram of a combined light-leakage prevention element, wherein A light represents imaging light, C light represents ambient light, and in FIG. 13, F3 represents the central wavelength, K curve represents a graph of the relationship between the ambient light transmittance of a reflection element and the wavelength, L curve represents a graph of the relationship between the ambient light transmittance of an absorption element and the wavelength, and M curve represents a graph of the relationship between the ambient light transmittance of a combined light-leakage prevention element and the wavelength. In this embodiment, the light-leakage prevention element 3 includes an absorption element and a reflection element which are stacked, the transmittance of the absorption element in the operating wavelength band is greater than the transmittance of the reflection element in the operating wavelength band, and the transmittance of the absorption element in the non-operating wavelength band is less than the transmittance of the reflection element in the non-operating wavelength band. This embodiment sets a combined light-leakage prevention element 5, including an absorption element and a reflection element which are stacked. The absorption element has a higher transmittance to ambient light in the operating wavelength band, and a lower transmittance in other bands; the reflection or diffraction element has a higher reflection or diffraction rate in the operating wavelength band, so its transmittance to ambient light is lower; and its reflectivity or diffraction rate in other bands is lower, so its transmittance to ambient light will be higher. After the two are used in combination, the transmittances of the operating wavelength band and the non-operating wavelength band are complementary, and their combination will have a uniform transmittance of ambient light in the operating wavelength band and the non-operating wavelength band, or in other words, in the entire visible light band. This not only reduces the light leakage phenomenon and improves the utilization rate of light energy, but also the wearer will see a normal and uniform scene when observing the outside.

In one embodiment, the reflection element is arranged on a side of the light-leakage prevention element close to the optical waveguide 1, and the absorption element is arranged on a side far from the optical waveguide 1. More light can be reflected to the grating 2 through the side close to the optical waveguide 1, thereby further reducing and improving the utilization rate of light energy.

According to another aspect of the present disclosure, the present disclosure further provides an augmented reality device, which includes the above-mentioned optical waveguide system. Since the augmented reality device includes all technical solutions of all embodiments of all the above-mentioned optical waveguide systems, it has at least all the beneficial effects brought by all the above-mentioned technical solutions, which will not be described one by one here.

The above are only optional embodiments of the present disclosure, and are not intended to limit the patent scope of the present disclosure. All equivalent structural changes made using the contents of the present disclosure's specification and drawings under the technical concept of the present disclosure, or directly/indirectly applied in other related technical fields, are included in the patent protection scope of the present disclosure.

1. An optical waveguide system, comprising an optical waveguide, wherein the optical waveguide comprises a first side face and a second side face opposite to each other, wherein the first side face is provided with a grating, and the second side face is provided with a light-leakage prevention element, wherein the light-leakage prevention element is configured to reduce light emitted from the second side face.

2. The optical waveguide system according to claim 1, wherein the light-leakage prevention element is configured to reflect light incident from the optical waveguide to the light-leakage prevention element, and an operating wavelength band of the light-leakage prevention element is consistent with an operating wavelength band of the grating.

3. The optical waveguide system according to claim 1, wherein the light-leakage prevention element is configured to reflect light incident from the optical waveguide to the light-leakage prevention element, an operating wavelength band of the light-leakage prevention element is included in an operating wavelength band of the grating, and a difference between a first central wavelength of the operating wavelength band of the light-leakage prevention element and a second central wavelength of the operating wavelength band of the grating is less than a first preset value.

4. The optical waveguide system according to claim 3, wherein a ratio between a width of the operating wavelength band of the light-leakage prevention element and a width of the operating wavelength band of the grating is smaller than a preset ratio, and the first central wavelength of the operating wavelength band of the light-leakage prevention element is the same as the second central wavelength of the operating wavelength band of the grating.

5. The optical waveguide system according to claim 1, wherein the grating includes a left side close to incident light and a right side opposite to the left side, and a reflection angle bandwidth range of the light-leakage prevention element includes an angle range from an edge field of view of the left side of the grating to an edge field of view of the right side of the grating.

6. The optical waveguide system according to claim 5, wherein within the reflection angle bandwidth range, a difference between reflectivity or diffraction efficiency corresponding to incident light at different angles is less than a second preset value; or
within the reflection angle bandwidth range, a fluctuation of the difference between reflectivity or diffraction efficiency corresponding to the incident light at different angles is less than a third preset value.

7. The optical waveguide system according to claim 6, wherein the second preset value is in a range of 5% to 10%, and the third preset value is in a range of 1% to 10%.

8. The optical waveguide system according to claim 1, wherein the light-leakage prevention element is configured to absorb light incident from the optical waveguide to the light-leakage prevention element, and an absorption wavelength band of the light-leakage prevention element is consistent with an operating wavelength band of the grating.

9. The optical waveguide system according to claim 1, wherein the light-leakage prevention element is configured to absorb light incident from the optical waveguide to the light-leakage prevention element, an absorption wavelength band of the light-leakage prevention element is included in an operating wavelength band of the grating, and a difference between a third central wavelength of the absorption wavelength band of the light-leakage prevention element and a fourth central wavelength of the operating wavelength band of the grating is less than a fourth preset value.

10. The optical waveguide system according to claim 9, wherein a ratio between a width of the absorption wavelength band of the light-leakage prevention element and a width of the operating wavelength band of the grating is smaller than a preset ratio, and the third central wavelength of the absorption wavelength band of the light-leakage prevention element is the same as the fourth central wavelength of the operating wavelength band of the grating.

11. The optical waveguide system according to claim 1, wherein the grating comprises a left side close to incident light and a right side opposite to the left side, and an absorption angle bandwidth range of the light-leakage prevention element includes an angle range from an edge field of view of the left side of the grating to an edge field of view of the right side of the grating.

12. The optical waveguide system according to claim 11, wherein within the absorption angle bandwidth range of the light-leakage prevention element, a difference between transmittance corresponding to incident light at different angles is less than a fifth preset value; or
within the absorption angle bandwidth range of the light-leakage prevention element, a fluctuation of the difference between transmittance corresponding to the incident light at different angles is less than a sixth preset value.

13. The optical waveguide system according to claim 12, wherein the fifth preset value is in a range of 5% to 10%, and the sixth preset value is in a range of 1% to 10%.

14. The optical waveguide system according to claim 1, wherein the light-leakage prevention element comprises an absorption element and a reflection element which are stacked, light transmittance of the absorption element in an operating wavelength band is greater than light transmittance of the reflection element in an operating wavelength band, and the light transmittance of the absorption element in a non-operating wavelength band is less than the light transmittance of the reflection element in a non-operating wavelength band.

15. The optical waveguide system according to claim 14, wherein the reflection element is disposed on a side of the light-leakage prevention element close to the optical waveguide.

16. An augmented reality device, comprising the optical waveguide system according to claim 1.
